(19) United States
(12) Patent Application Publication
(10) Pub. No.: US 2015/0181313 A1
(43) Pub. Date: Jun. 25, 2015

(54) METHOD OF OPERATING AN INFRARED TEMPERATURE MAGNET WITH AN RFID ANTENNA

(71) Applicant: Aktiebolaget SKF, Goteborg (SE)

(72) Inventor: Jonathan D. Murphy, Friday Harbor, WA (US)

(73) Assignee: Aktiebolaget SKF, Goteborg (SE)

(21) Appl. No.: 14/136,764

(22) Filed: Dec. 20, 2013

(51) Int. Cl. H04Q 9/00; G01H 1/00; G01J 5/00; H04W 4/00; G06K 7/10

(52) U.S. Cl. CPC H04Q 9/00; H04W 4/008; G06K 7/10366; G01J 5/00; G01H 1/00

(57) ABSTRACT

A method of collecting vibration and temperature data with a mobile data collector electro-mechanically connected to a sensory head is proposed. The data collected from a surface of a machine housing having an RFID tag mounted thereon. The method includes the steps of providing the sensory head electrically connected to the mobile data collector and mechanically connected to the machine housing surface, the sensory head including an infrared sensor, an RFID antenna, and at least one magnetic coupling. The sensory head attached to the machine housing surface via the magnetic coupling to enable transmission of machinery vibration through to the mobile data collector. The RFID antenna is positioned proximate the RFID tag and the infrared temperature sensor proximate the machine housing surface. A unique machine asset identifier is read into the mobile data collector via the sensory head RFID antenna and then uploaded into the mobile data collector.

### FIELD OF THE INVENTION

The present disclosure generally relates to a method of operating an infrared temperature magnet. More particularly, the present disclosure relates to a method of operating an infrared temperature magnet having an RFID antenna.

### BACKGROUND OF THE INVENTION

Data collection is a complicated and expensive effort. The data collecting devices are expensive, too big to put in a pocket and require significant training to use. Data collection usually involves several button presses and complex screens per each measurement taken.

Data is often collected to monitor the operation of industrial machines. Such data collection may be used to diagnose problems, troubleshoot, trend operating changes, or otherwise record data points indicative of machine operation. A variety of data types may be collected, including temperature, vibration, and the like. The data collection may be continuous, i.e., using dedicated resources for individual machines or groups of machines. In other cases, data collection may be on-demand, for example, in routine checking and maintenance of the machines. In the latter case, mobile units may be provided that use sensors that are either permanently or temporarily coupled with the machine being measured.

Such on-demand data collection may, however, be costly in terms of time and resources. For example, if several machines are being checked using a mobile unit, complexity in the operation of the data collection unit may be multiplied and may require significant time allocation. Further, bulkiness of such units may hinder movement between machines being measured. However, a reduction in unit size may reduce functionality, such as the ability to retain measurements from previous operations, execute data collection/management software, etc. Complexity may also introduce the possibility of human error, and thus resources may be expended in training users to operate the units.

Furthermore, with mobile units, since they may capture data about several different machines in a session, care must be taken to establish the correct operating conditions to be monitored, associated with the correct machine, and with the correct operating constraints applied thereto, etc. Typically, this requires significant investments in training personnel responsible for collecting the data using the mobile units, and in software to manage the collected data and minimize error.

### SUMMARY OF THE INVENTION

Embodiments of the disclosure may provide a method of collecting vibration and temperature data with a mobile data collector electro-mechanically connected to a sensory head, the mobile data collector having a sensing element disposed therein, the data being collected from a surface of a machine housing having an RFID tag mounted thereon, the method including the steps of providing the sensory head electrically connected to the mobile data collector and mechanically connected to the machine housing surface, the sensory head including an infrared sensor, an RFID antenna, and at least one magnetic coupling, attaching the sensory head to the machine housing surface via the magnetic coupling in order to enable transmission of machinery vibration through to the mobile data collector, positioning the RFID antenna proximate the RFID tag and the infrared temperature sensor proximate the machine housing surface, reading a unique machine asset identifier stored within the RFID tag into the mobile data collector via the sensory head RFID antenna, uploading the unique machine asset identifier through the sensory head into the mobile data collector, transmitting the machinery vibration directly through the sensory head to the sensing element disposed within the mobile data collector, measuring a temperature of the machine housing with the infrared sensor, and uploading the measured machine housing temperature into the mobile data collector.

Embodiments of the disclosure may provide a method of collecting and storing vibration and temperature data with a mobile data collector in electro-mechanical communication with a sensory head, the mobile data collector having a memory and a sensing element, the data being collected from a surface of a machine housing having an RFID tag mounted thereon, the method including the steps of providing the sensory head in electro-mechanical communication with both the mobile data collector and the machine housing surface, the sensory head including an infrared sensor, an RFID antenna, and at least one magnetic coupling, attaching the sensory head to the machine housing surface via the magnetic coupling in order to enable transmission of machinery vibration, positioning the IR Temperature Sensor proximate the machine housing surface and the RFID antenna proximate the RFID tag, transmitting the machinery vibration directly through the sensory head to the sensing element disposed within the mobile data collector and storing it within the memory, reading a unique machine asset identifier stored within the RFID tag into the sensory head via the RFID antenna, transmitting the unique machine asset identifier through the antenna disposed within the sensory head into the mobile data collector and storing the value in the memory, measuring the temperature of the machine housing with the infrared sensor, and transmitting the measured machine housing temperature by the infrared sensor into the memory of the mobile data collector.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 is a perspective view of a sensing system according to a preferred embodiment of the present invention;

FIG. 2 is an elevated exploded view of sensing device according to a preferred embodiment of the present invention;

FIG. 3 is an elevated perspective view of a contact according to a preferred embodiment of the present invention;

FIG. 4 is an elevated perspective view of an isolator body according to a preferred embodiment of the present invention;

FIG. 5 is an elevated perspective view of a body shell according to a preferred embodiment of the present invention;

FIG. 6 is an elevated perspective view of printed circuit board according to a preferred embodiment of the present invention;

FIG. 7 is an elevated perspective view of an infrared temperature sensor according to a preferred embodiment of the present invention;

FIG. 8 is an elevated perspective view of a hood for an infrared temperature sensor according to a preferred embodiment of the present invention;

FIG. 9 is a flow diagram illustrating a method of operating the sensing system according to a preferred embodiment of the present invention; and

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Hence, specific dimensions and other physical characteristics relating to the embodiments disclosed herein are not to be considered as limiting, unless the claims expressly state otherwise. Also, it should be noted that a wire, electrical contact, electrical connector, etc., could be used as the form of electrical communication between internal device components.

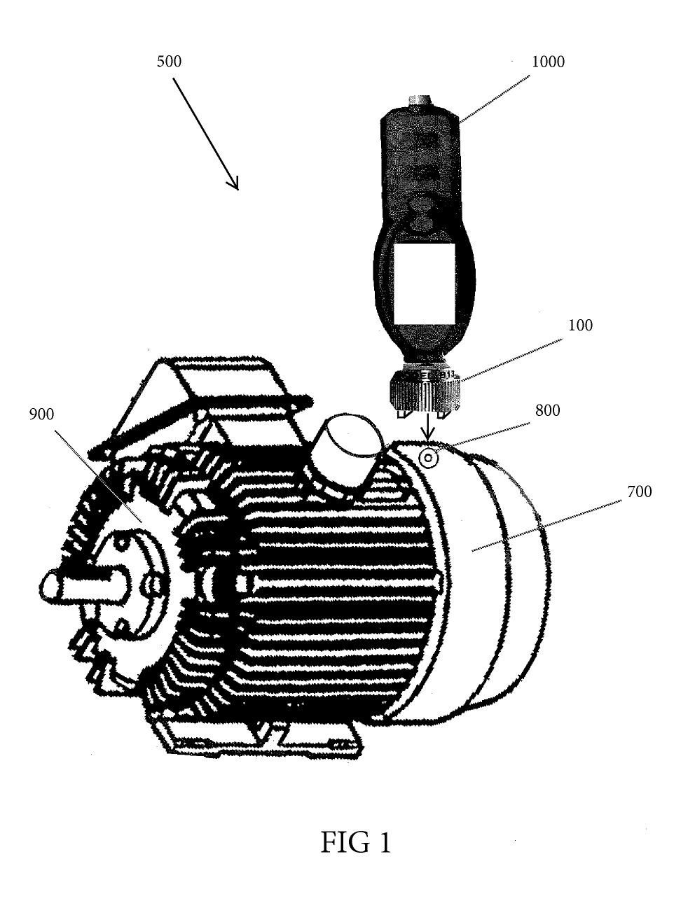

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims.

A sensing system 500 that provides a sensory head 100 which is in electro-mechanical communication with a mobile data collector 1000 is illustrated in FIG. 1. The sensory head 100 senses a temperature of and transmits vibration emitted from a machine housing 700 having an RFID tag 800 disposed thereon. The machine housing could also be a bearing housing and be in mechanical communication with a piece of rotating equipment 900.

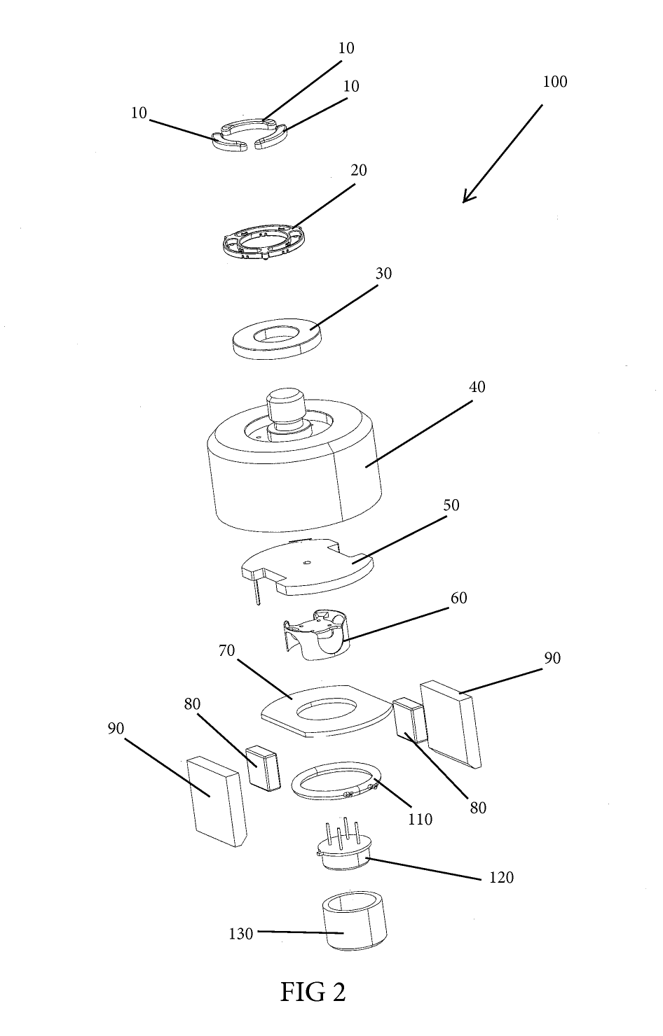

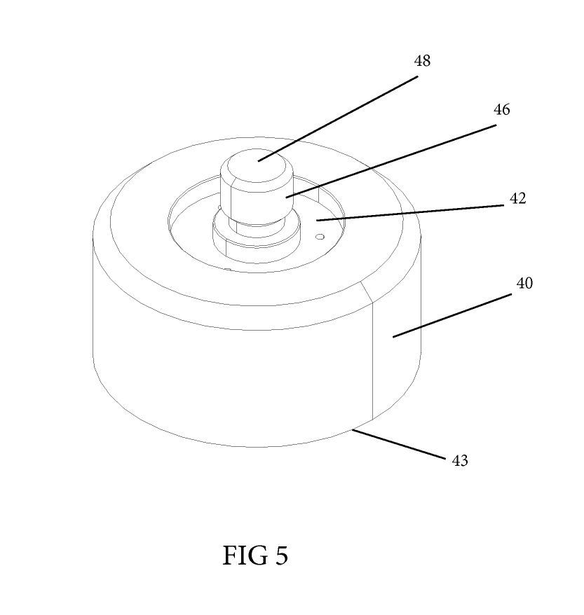

An exploded view of the sensing device 100 and its components is illustrated in FIG. 2. The device 100 includes a body shell 40 for housing the sensing device 100 and a threaded stud 46 for mounting the device. A system ground connection 48 is integrated into the mounting stud 46 of the body shell 40. See now FIGS. 2 and 5. The mobile data collector 1000 includes a corresponding female threaded recess. On assembly, the threaded stud 46 of the sensing device 100 is screwed into the female threaded recess of the mobile data collector 1000 until the threads stop.

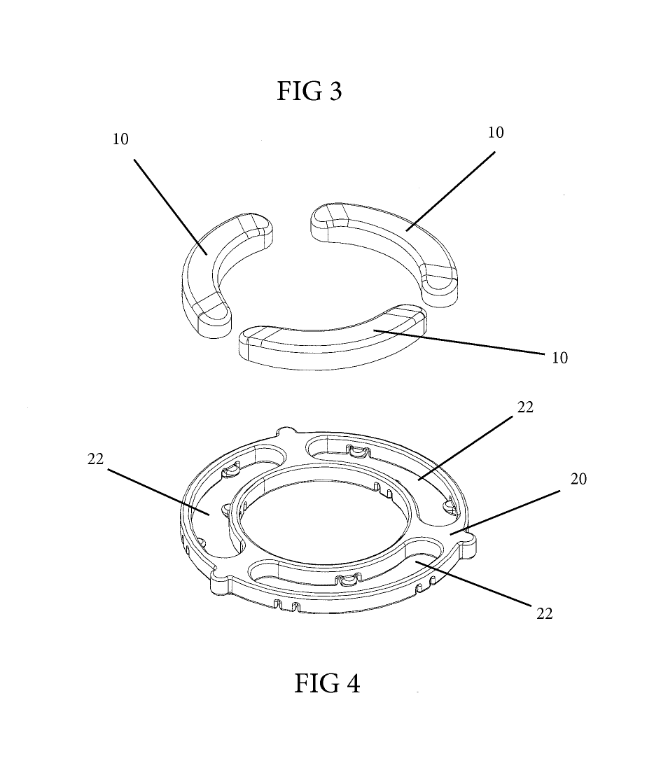

At least one contact 10 for delivering power to the sensing device 100 and for providing at least one of a digital Input signal into the device 100 and a digital output signal out of the sensing device 100 are illustrated in FIGS. 2-4 (digital I/O signal). In this embodiment, the device provides three individual contacts 10. As such, the at least one digital input, digital output and power contact 10 further provides three semi-circular contact rings 10 disposed within semi-circular recesses 22 disposed within isolator body 20. The isolator body 20 separates the three semi-circular contact rings 10 from coming into contact with each other. The isolator body 20 and three semi-circular rings 10 are potted into an annular recess 42 disposed within the shell body 40 with a resin 30 for strength. As can be seen, top and side portions of the contacts are still exposed. As such, when the mobile data collector 1000 and sensing device 100 are screwed together the three contacts 10 come into contact with a corresponding set of three contacts disposed thereon on the mobile data collector 1000. The sets of threads are positioned so that the contacts properly align with each other and do not short out when the threads stop and assembly is complete.

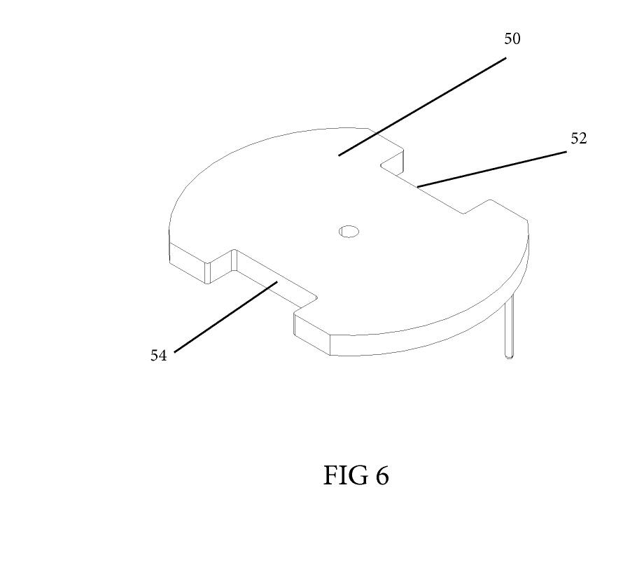

As illustrated in FIGS. 2 and 6, the device 100 also provides a combination power and control circuit 50 for powering the control circuit and for controlling function of the sensing device 100. The combination power and control circuit 50 is in electrical communication with the at least one contact 10. Here, the combination power and control circuit may be provided in the form of a printed circuit board or PCB.

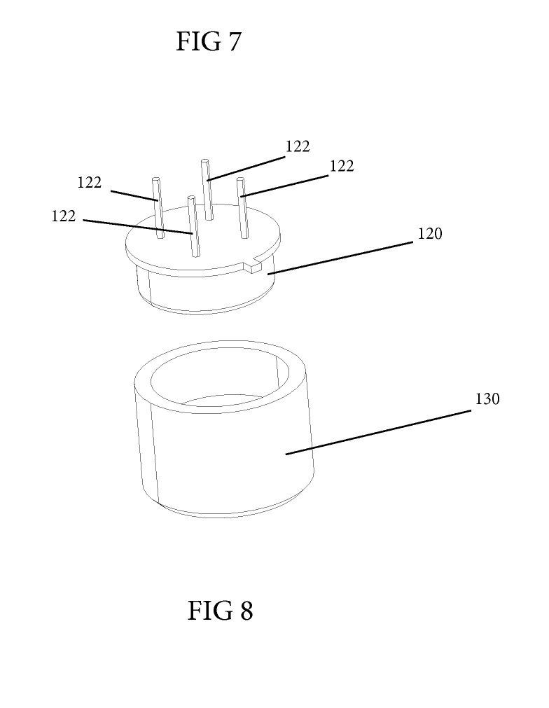

An infrared temperature sensor 120 for measuring the sensed temperature of the machine housing is further provided and is illustrated in FIG. 2. The infrared temperature sensor 120 is in electrical communication with the PCB 50. The infrared temperature sensor 120 has a hood 130 that shields the infrared temperature sensor 120 from outside elements. The sensing device includes an infrared/antenna spacer 60 for mounting and locating the infrared sensor 120 and sensor hood 130 within the device body 40. See now FIGS. 2, 7-8.

Here, the invention contemplates that the machine or bearing housing 700 already has an RFID tag 800 disposed thereon. The RFID tag 800 provides a unique identifier for the piece of machinery or asset in an inventory of equipment. In order to link a specific asset with its sensed temperature and vibration emissions, the device provides an RFID antenna 110 supplied in the form of a tuned loop of wire. As such, the RFID antenna reads the RFID tag attached to the machine housing and enables transmission of the unique tag identification into the mobile data collector 1000.

The RFID antenna could also be an RFID spiral antenna or a wound inductor antenna mounted on an antenna plate 70. Here, the RFID antenna 110 is in electrical communication with the PCB 50 via leads 122, which in turn is in electrical communication with at least one of the contacts 10. As previously disclosed, the at least one contact transmits the read tag information through a digital output signal and out of the sensing device 100 into the mobile data collector 1000. To provide structure, the antenna 110 and mounting plate 70 are potted with a resin that protects and secures the antenna within the body shell 40 of the sensing device 100. The resin does not extend beyond a base 43 of the body shell 40.

The sensing device 100 includes at least one magnet 80 that is used to magnetically attach the sensing device 100 to the machine housing. In this embodiment, the at least one magnet 80 provides two magnets. The two magnets get inserted into slots 52, 54 that are disposed within the PCB 50. The sensing device 100 further has at least one mounting foot 90 that is fabricated from a high permeability material. The at least one magnetic foot 90 transmits the magnetic flux emitted from the at least one magnet 80 to the machine housing 700. It should be understood that the at least one magnet and at least one mounting foot could be provided in any shape or size that fits the application and not limited to what is necessarily illustrated.

When the sensing device 100 is magnetically attached to the machine housing 700, transmission of machinery vibration from the machine housing through the sensing device to the mobile data collector 1000 is enabled. When the sensing device 100 is installed proximate to the RFID tag 800, the infrared temperature sensor 120 takes a temperature measurement of the machine housing and enables transmission to the mobile data collector 1000.

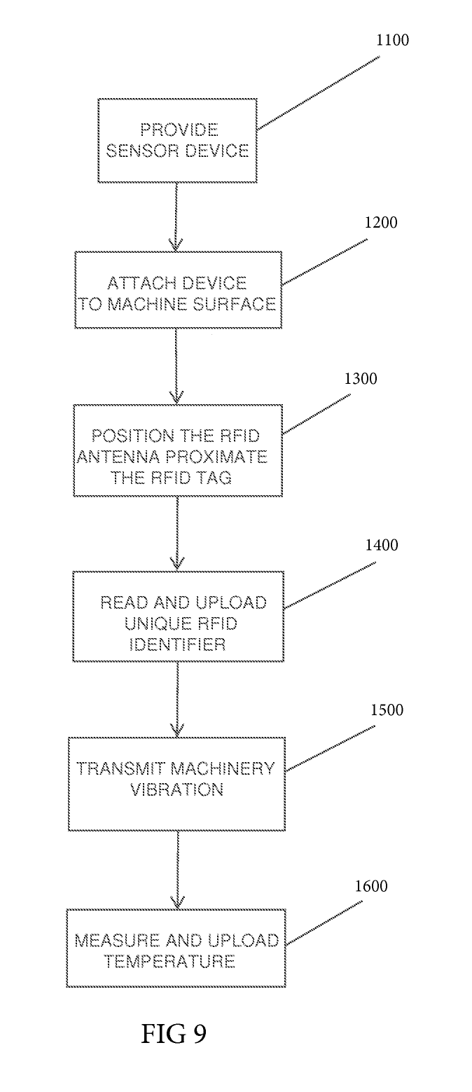

A method of collecting and storing vibration and temperature data with a mobile data collector 1000 in electro-mechanical communication with a sensory head 100 will now be disclosed and illustrated in FIG. 9. The mobile data collector 1000 includes a memory and sensing element disposed therein. In the present embodiment, the sensing element is an accelerometer. The data is collected from a surface of a machine housing 700 which already has an RFID tag 800 mounted thereon.

In a first step 1100, the method includes providing the sensory head 100 being in electro-mechanical communication with both the mobile data collector and machine housing surface, the sensing device having an infrared sensor, an RFID antenna, and at least one magnetic coupling disposed therein.

In step 1200, the sensory head 100 is physically attached to the machine housing surface via the magnetic coupling. This enables transmission of machinery vibration through to the mobile data collector.

In step 1300, after the sensing device is attached to the machine housing surface, the RFID antenna is positioned proximate the RFID tag and finally the infrared temperature sensor is positioned proximate the machine housing surface.

A unique machine asset identifier stored within the RFID tag is read into the sensory head via the RFID antenna in step 1400 and uploaded through the sensory head into the memory of the Mobile data collector.

In step 1500, the machinery vibration is transmitted directly through the sensory head to the accelerometer disposed within the mobile data collector.

During final step 1600, a temperature of the machine housing is measured with the infrared sensor and is then uploaded into the memory of the mobile data collector for processing. The step of uploading the measured machine housing temperature by the infrared sensor into the vibration probe is communicated by the digital output signal generated by the sensing device 100.

1. A method of collecting vibration and temperature data with a mobile data collector electro-mechanically connected to a sensory head, the mobile data collector having a sensing element disposed therein, the data being collected from a surface of a machine housing having an RFID tag mounted thereon, the method comprising the steps of:
providing the sensory head electrically connected to the mobile data collector and mechanically connected to the machine housing surface, the sensory head including an infrared sensor, an RFID antenna, and at least one magnetic coupling,
attaching the sensory head to the machine housing surface via the magnetic coupling in order to enable transmission of machinery vibration through to the mobile data collector,
positioning the RFID antenna proximate the RFID tag and the infrared temperature sensor proximate the machine housing surface,
reading a unique machine asset identifier stored within the RFID tag into the mobile data collector via the sensory head RFID antenna,
uploading the unique machine asset identifier through the sensory head into the mobile data collector,
transmitting the machinery vibration directly through the sensory head to the sensing element disposed within the mobile data collector,
measuring a temperature of the machine housing with the infrared sensor, and
uploading the measured machine housing temperature into the mobile data collector.

2. The method of collecting vibration and temperature data with a mobile data collector according to claim 1, wherein the machine housing surface is disposed on a piece of rotating equipment.

3. The method of collecting vibration and temperature data with a mobile data collector according to claim 1, wherein the sensory head further includes a male threaded portion and the mobile data collector includes a mating female threaded portion.

4. The method of collecting vibration and temperature data with a mobile data collector according to claim 3, further comprising a step rotatably fastening the male thread of the sensory head into the female threaded portion of the mobile data collector until the threads lock, this step being carried out prior to attaching the sensory head via the magnetic coupling to the machine housing surface.

5. The method of collecting vibration and temperature data with a mobile data collector according to claim 1, wherein the sensing element further comprises an accelerometer.

6. The method of collecting vibration and temperature data with a mobile data collector according to claim 1, wherein the machine housing surface is a made from a high permeability material.

7. The method of collecting vibration and temperature data with a mobile data collector according to claim 1, wherein the step of uploading the measured machine housing temperature by the infrared sensor into the vibration probe is communicated by a digital output signal.

8. A method of collecting and storing vibration and temperature data with a mobile data collector in electro-mechanical communication with a sensory head, the mobile data collector having a memory and a sensing element, the data being collected from a surface of a machine housing having an RFID tag mounted thereon, the method comprising the steps of:
providing the sensory head in electro-mechanical communication with both the mobile data collector and the machine housing surface, the sensory head including an infrared sensor, an RFID antenna, and at least one magnetic coupling,
attaching the sensory head to the machine housing surface via the magnetic coupling in order to enable transmission of machinery vibration,
positioning the IR Temperature Sensor proximate the machine housing surface and the RFID antenna proximate the RFID tag,
transmitting the machinery vibration directly through the sensory head to the sensing element disposed within the mobile data collector and storing it within the memory,
reading a unique machine asset identifier stored within the RFID tag into the sensory head via the RFID antenna,
transmitting the unique machine asset identifier through the antenna disposed within the sensory head into the mobile data collector and storing the value in the memory,
measuring the temperature of the machine housing with the infrared sensor, and
transmitting the measured machine housing temperature by the infrared sensor into the memory of the mobile data collector.

9. The method of collecting and storing vibration and temperature data with a mobile data collector according to claim 8, wherein the machine housing surface is disposed on a piece of rotating equipment.

10. The method of collecting and storing vibration and temperature data with a mobile data collector according to claim 8, wherein the sensory head further includes a male threaded portion and the mobile data collector includes a mating female threaded portion.

11. The method of collecting and storing vibration and temperature data with a mobile data collector according to claim 9, further comprising the step rotatably fastening the male thread of the sensory head into the female threaded portion of the mobile data collector, and wherein the step of rotatably fastening the sensory head into the mobile data collector is carried out prior to attaching the sensory head via the magnetic coupling to the machine housing surface.

12. The method of collecting and storing vibration and temperature data with a mobile data collector according to claim 8, wherein the sensing element further comprises an accelerometer.

13. The method of collecting and storing vibration and temperature data with a mobile data collector according to claim 8, wherein the machine housing surface is a made from a high permeability material.

14. The method of collecting and storing vibration and temperature data with a mobile data collector according to claim 8, wherein the step of transmitting the measured machine housing temperature by the infrared sensor into the mobile data collector is communicated by a digital output signal.
